(19) United States
(12) Patent Application Publication
(10) Pub. No.: US 2010/0166270 A1
(43) Pub. Date: Jul. 1, 2010

(54) METHOD, APPARATUS, GRAPHICAL USER INTERFACE, COMPUTER-READABLE MEDIUM, AND USE FOR QUANTIFICATION OF A STRUCTURE IN AN OBJECT OF AN IMAGE DATASET

(75) Inventors: Rafael Wiemker, Kisdorf (DE); Thomas Buelow, Grosshansdorf (DE); Roland Opfer, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/376,456

(22) PCT Filed: Jul. 30, 2007
(86) PCT No.: PCT/IB07/53003

§ 371 Date: Feb. 5, 2009

(30) Foreign Application Priority Data
Aug. 9, 2006 (EP) 06118650.8

(51) Int. Cl. G06K 9/00

(52) U.S. Cl. 382/128

(57) ABSTRACT

The present invention describes a way to quantify the trapped-air disease and how to allow efficient user interaction for inspection via a graphical user interface. The results of the invention may also be used for rapid and accurate diagnosis of trapped air disease. An apparatus, graphical user interface, computer-readable medium and use are also provided.

### FIELD OF THE INVENTION

This invention pertains in general to the field of medical imaging. More particularly the invention relates to quantification of a structure in an object of a medical image dataset, such as a medical image dataset obtained by means of medical imaging modalities such as Computed Tomography (CT) and Magnetic Resonance Imaging (MRI).

### BACKGROUND OF THE INVENTION

Chronic Obstructive Pulmonary Disease, COPD, is a group of lung diseases characterized by an obstruction in airflow. According to statistical data, it is the fourth leading cause of death in the United States, and is currently the only common cause of death that is increasing in incidence. COPD includes chronic bronchitis and emphysema, which are most often caused by heavy, long-time cigarette smoking. The disease may also be initiated by long-term exposure to industrial pollutants and scarred lung tissue. COPD can also include chronic asthma, which is a hypersensitivity of the air passages in the lungs. Bronchitis, emphysema, and asthma all have in common that they limit the flow of air into and out of a persons' lungs. As a result, the affected person may cough, wheeze, have excess mucus, feel short of breath, and have susceptibility to lung infection.

Anatomically, one reason for COPD are pockets of air, which are trapped within the lung region without the possibility of gas exchange with the pulmonary alveoli or the pulmonary airway tree. The air may get trapped there either from the lungs themselves or from outside the human body.

Furthermore, chronic irritation of the lungs causes inflammation, which prompts the lungs to produce more mucus. Moreover, the mucus partially or completely blocks the bronchioles, such that only very small amounts of air can reach and communicate with the lungs' alveoli (small air sacs for gas exchange in the lungs). Eventually, the bronchioles become permanently narrowed, and many of the alveolar walls are destroyed, enlarging the air spaces. Air becomes trapped in these enlarged alveoli without having the possibility of gas exchange with the airway tree.

At present, the COPD disease may be spotted in a CT dataset by visual inspection of trained medical personnel, but may only be evaluated qualitatively. Current quantification techniques rely totally on manual delineation in all CT slice images. Accordingly, the manual delineation is very time-consuming, e.g. for 300 slice images with 20 seconds per slice manual delineation time, a total manual image treatment time of 100 minutes results, which is thus forbiddingly long for the clinical practice requiring short patient handling times, at least of economical reasons and for patient convenience.

US 2005/0240094 A1 discloses a system and a method for visualizing a tree structure in a medical image. The method comprises segmenting the tree structure in the image data, coloring an exterior of the tree structure using data associated with interior components of the tree structure and outputting an image of the structure colored by the interior components of the tree structure. However, US 2005/0240094 A1 does not provide a way to quantify trapped air in the lungs.

Hence, an improved method for determination of trapped air allowing for increased flexibility, cost-effectiveness, and time efficiency would be advantageous.

### SUMMARY OF THE INVENTION

Accordingly, the present invention preferably seeks to mitigate, alleviate or eliminate one or more of the above-identified deficiencies in the art and disadvantages singly or in any combination and solves at least the above-mentioned problems by providing a method, graphical user interface, apparatus, computer-readable medium, and use according to the appended patent claims.

According to an aspect of the invention a method is provided for quantification of a structure in a medical image dataset having a plurality of voxels, each voxel having a Hounsfield value (HU), wherein the structure comprises a seed voxel and a first voxel that initially are identical. The method comprises inserting the first voxel as a first element into a queue, in which voxels are organized by increasing Hounsfield value, and repeating:

identifying a first set of neighbor voxels to the first element of the queue, having Hounsfield values under a predetermined threshold, inserting the first set of neighbor voxels into the queue, registering for the first voxel the Hounsfield value encountered on a path originating from the seed voxel, wherein the path is a sequence of voxels comprised in the plurality of voxels and wherein each successive voxel of the path is a neighbor voxel of a previously processed voxel, and that each voxel of the path is chosen from the queue,

calculating the difference or ratio between the maximum Hounsfield value of all voxels on the path and the Hounsfield value of the first voxel to quantify the structure voxel by voxel, marking the first voxel, such that it subsequently not will enter the queue again,

until all remaining unprocessed voxels are processed and the queue is empty.

According to an aspect of the invention a graphical user interface is provided for visualizing quantification of a structure in a medical image dataset by a color overlay over the medical image dataset, wherein the color intensity corresponds to the quantification of a structure calculated by the method according to any one of the claims 1-11.

According to a further aspect of the invention an apparatus is provided for quantification of a structure in a medical image dataset having a plurality of voxels, each voxel having a Hounsfield value (HU), wherein the structure comprises a seed voxel and a first voxel that initially are identical. The apparatus comprises an inserting unit for inserting the first voxel as a first element into a queue, in which voxels are organized by increasing Hounsfield value, and

a repeating unit comprising:

an identifying unit for identifying a first set of neighbor voxels to the first element of the queue, having Hounsfield values under a predetermined threshold, an inserting unit for inserting the first set of neighbor voxels into the queue, a registering unit registering for the first voxel the Hounsfield value encountered on a path originating from the seed voxel, wherein the path is a sequence of voxels comprised in the plurality of voxels and wherein each successive voxel of the path is a neighbor voxel of a previously processed voxel, and that each voxel of the path is chosen from the queue, a calculating unit for calculating the difference or ratio between the maximum Hounsfield value of all voxels on the path and the Hounsfield value of the first voxel to quantify the structure voxel by voxel, a marking unit for marking the first voxel, such that it subsequently not will enter the queue again,

for repeating until all remaining unprocessed voxels are processed and the queue is empty.

According to yet another aspect a computer readable medium, having embodied thereon a computer program for processing by a computer is provided for quantification of a structure in a medical image dataset having a plurality of voxels, each voxel having a Hounsfield value (HU), wherein the structure comprises a seed voxel and a first voxel that initially are identical. The computer program comprises an inserting code segment for inserting the first voxel as a first element into a queue, in which voxels are organized by increasing Hounsfield value, and a repeating code segment comprising:

an identifying code segment for identifying a first set of neighbor voxels to the first element of the queue, having Hounsfield values under a predetermined threshold, an inserting code segment for inserting the first set of neighbor voxels into the queue, a registering code segment registering for the first voxel the Hounsfield value encountered on a path originating from the seed voxel, wherein the path is a sequence of voxels comprised in the plurality of voxels and wherein each successive voxel of the path is a neighbor voxel of a previously processed voxel, and that each voxel of the path is chosen from the queue, a calculating code segment for calculating the difference or ratio between the maximum Hounsfield value of all voxels on the path and the Hounsfield value of the first voxel to quantify the structure voxel by voxel, a marking code segment for marking the first voxel, such that it subsequently not will enter the queue again,

for repeating until all remaining unprocessed voxels are processed and the queue is empty.

According to yet a further aspect of the invention a use of the method according to claims 1-18, for diagnosing trapped air in a patient is provided.

The present invention describes a way to quantify the trapped-air disease and how to allow efficient user interaction for inspection (graphical user interface). The results of the invention may also be used for rapid and accurate diagnosis of trapped air disease.

The invention may be provided as a software option to CT/MR/US/X-ray scanner consoles, imaging workstations (such as Philips ViewForum, Extended Brilliance Workspace), and PACS workstations (such as Philips iSite), and thus increase the competitiveness of the overall scanner system. The described invention may assist the diagnosis by offering computer assisted detection and quantification of trapped air in the lung region.

### BRIEF DESCRIPTION OF THE DRAWINGS

These and other aspects, features and advantages of which the invention is capable of will be apparent and elucidated from the following description of embodiments of the present invention, reference being made to the accompanying drawings, in which:

FIG. 1 is a medical image showing an example of trapped air pockets;

FIG. 2 is a flow chart illustrating a heritage path according to an embodiment;

FIG. 3 is a flow chart illustrating a method according to an embodiment;

FIG. 4 is a flow chart illustrating a method according to an embodiment;

FIG. 5 is a graphical illustration showing the principle of a method according to an embodiment;

FIG. 6a is an illustration showing graphical user interface according to an embodiment;

FIG. 6b is an illustration showing a zoomed view of the Maximum Intensity Projection in a graphical user interface as shown in FIG. 6a;

FIG. 7 is a schematical illustration showing an apparatus according to an embodiment;

FIG. 8 is a schematical illustration showing an apparatus according to an embodiment;

FIG. 9 is a schematical illustration showing a computer-readable medium according to an embodiment; and

FIG. 10 is a schematical illustration showing a computer-readable medium according to an embodiment.

### DESCRIPTION OF EMBODIMENTS

The following description focuses on embodiments of the present invention applicable to medical imaging and in particular to quantification of trapped air in the lungs of a patient. However, it will be appreciated that the invention is not limited to this application but may be applied to many other areas wherein quantification of structures in a volume of interest is desired.

The present invention describes a way to quantify the trapped-air disease and how to allow efficient user interaction for inspection (graphical user interface). The results of the invention may also be used for rapid and accurate diagnosis of trapped air disease.

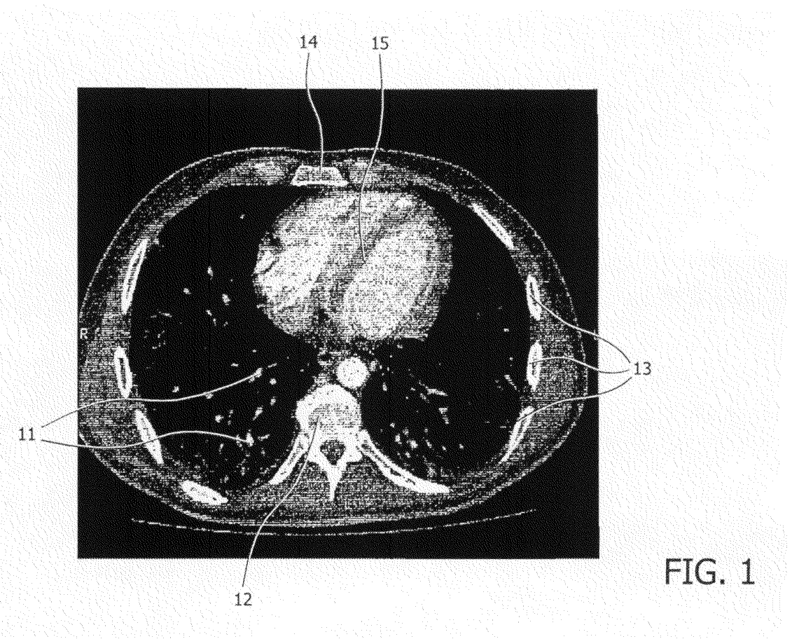

FIG. 1 illustrates an example of trapped air pockets 11 in the lungs of a patient. A slice through the torso of a patient is shown, clearly identifying the chest region including the body boundary and therein the spine 12, some ribs 13, the sternum 14 and in the chest cavity the heart 15, some central vessels and the right and left lungs. The trapped air pockets 11 are identifiable within the lung regions of the exemplary image of FIG. 1.

The present invention provides a method for locating trapped air in the human body, such as in the lung region of a patient. The basic idea is to analyze a medical image dataset, such as a Computed Tomography (CT), to locate the trapped air. The method utilizes a seed voxel in the trachea to perform segmentation to identify the trapped air locations in the lung region.

Segmentation is a well-known concept within the field of image analysis concept in which an image dataset is partitioned into multiple regions (sets of pixels), according to a given criterion. Thus, the goal of segmentation is generally to locate structures of interest within the image dataset. A subgroup to segmentation is the commonly known region growing technique, which is a technique that starts from a seed voxel and then expands to all voxels of the image dataset. Region growing is a commonly known technique within the field of image analysis and is a subgroup to segmentation in which similar structures are identified originating from a seed pixel or seed voxel in the image dataset. The “growing” term implies that similar pixels/voxels adjacent to the seed pixels are grouped together based on some criterion and thus similar pixels/voxels successively grow into similar structure(s) comprised in the image dataset. The region growing may proceed to all voxels of the medical image dataset of the human body, e.g. the trachea, airways and lungs, starting from the seed voxel. The segmentation, such as region growing, used in the method is prioritized such that voxels with Hounsfield values (HU) that are lower than a predetermined threshold, such as −400 HU, are processed first.

The Hounsfield value HU is a known parameter used in medical imaging, such as Computed Tomography and Magnetic Resonance Imaging scanning, to describe the amount of x-ray attenuation of each voxel in the three-dimensional image. The skilled person is aware of calculation methods to obtain the Hounsfield value. The voxels are normally represented as 12-bit binary numbers, and therefore have in that case 2¹²=4096 possible values. These values are arranged on a scale from −1024 HU to +3071 HU, calibrated so that −1024 HU is the attenuation produced by air and 0 HU is the attenuation produced by water. Tissue and bone then produce attenuations in the positive range. The reading in Hounsfield units is also called the CT number. The Hounsfield values are lowest in the trachea and airways for pure air, e.g. −1000 HU. The Hounsfield values are higher, e.g. −900 HU, depending on the slice thickness of the CT scan, in the smaller airways due to limited resolution and partial volume effect, and higher still, e.g. −800 HU, in the denser lung parenchymal tissue.

The segmentation used in the method may utilize a queue, which is a standard data structure in which elements are sorted based on some criterion before being processed one by one. In an embodiment of the present invention the elements, i.e. voxels (3D) or pixels (2D), of the queue are sorted based on their Hounsfield value in increasing order.

After the segmentation of the trapped air structure in the medical image dataset each voxel value is compared to the maximum value encountered on its heritage path. The heritage path used in the present specification may be defined as follows: all voxels of the image dataset will have a heritage path leading back to the seed voxel in the trachea. The definition of the heritage path is that each successive voxel of the heritage path is a neighbor voxel of a previously processed voxel, and that each voxel of the heritage path was chosen from the queue. This means that the heritage path for each voxel will have a tree structure with the seed voxel as the originating voxel, and extend throughout the 3D medical image dataset in a neighbor defined manner. Furthermore the heritage path may is a 3D path for a 3D medical image dataset that extend itself throughout the 3D medical image dataset.

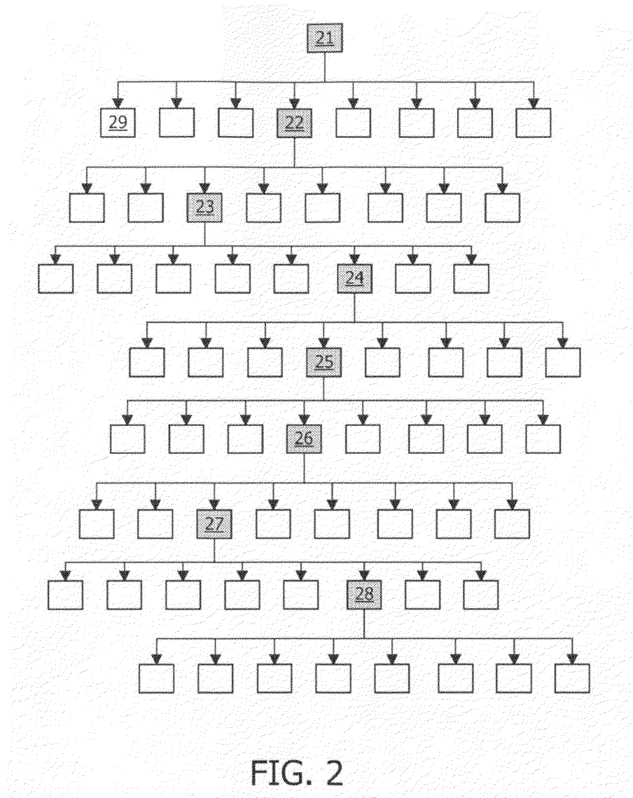

FIG. 2 illustrates an example of a heritage path in 2D, i.e. 8 direct neighbor voxels/pixels to each voxel, starting from the seed voxel 21. Each successive neighbor voxel 22-28 of the heritage path is illustrated. FIG. 2 illustrates only one heritage path 21-28. Each of the other neighbor voxels each has at least one heritage path. For the neighbor voxels in the neighborhood corresponding to voxel 22 there are 8 heritage paths available, for the next neighborhood corresponding to voxel 23 8²=64 heritage paths are available. Accordingly in the neighborhood corresponding to voxel 28 there are 8⁷=2097152 heritage paths available. A heritage path ends when all of the neighbor voxels either are above the predetermined threshold or are previously processed in the method.

The method according to some embodiments locates the occurrence of trapped air in the lung and hence, based on that the analyzed voxels are required to be under the predetermined threshold value, the longest heritage path after the method is completed illustrates in some way the path of the air from the trachea to the lungs of the patient.

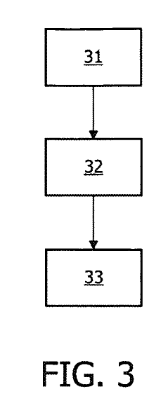

In an embodiment, according to FIG. 3, a method for quantification of trapped air, hereinafter also denoted trappedness, e.g. in the lung region of a patient, in a medical image dataset is provided. The method comprises:

performing 31 segmentation of the medical image dataset to identity the trapped air, wherein the segmentation is based on processing each voxel in the medical image dataset in the order of its respective Hounsfield value,

registering 32 the maximum Hounsfield value encountered so far on a heritage path from the seed voxel, wherein the heritage path for all voxels in the image dataset begins with the seed voxel,

calculating 33 the trapped air for each voxel by comparing the maximum heritage path Hounsfield value and the actual voxel Hounsfield value, e.g. as a difference or ratio. The trapped air is in this manner separated and quantified from other voxels of the medical image dataset such as voxels describing the bronchial airway tree.

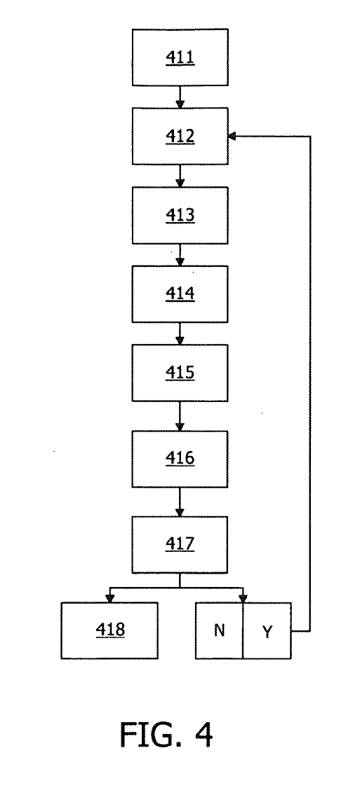

In another embodiment, according to FIG. 4, a method is provided for quantification of a structure in a medical image dataset having a plurality of voxels, each voxel having a Hounsfield value (HU), wherein the structure comprises a seed voxel and a first voxel that initially are identical. The method comprises:

inserting 411 the first voxel as a first element into a queue, in which voxels are organized by increasing Hounsfield value, and repeating:

identifying 412 a first set of neighbor voxels to the first element of the queue, having Hounsfield values under a predetermined threshold,

inserting 413 the first set of neighbor voxels into the queue,

registering 414 for the first voxel the Hounsfield value encountered on a path originating from the seed voxel, wherein the path is a sequence of voxels comprised in the plurality of voxels and wherein each successive voxel of the path is a neighbor voxel of a previously processed voxel, and that each voxel of the path is chosen from the queue,

calculating 415 the difference or ratio between the maximum Hounsfield value of all voxels on the path and the Hounsfield value of the first voxel to quantify the structure voxel by voxel,

marking 416 the first voxel and the first set of neighbor voxels, such that they subsequently not will enter the queue again,

until all remaining unprocessed voxels are processed and the queue is empty. Optionally the method further comprises deleting 417 the first voxel from the queue.

Moreover, as long as there are still voxels in the queue, indicated as Y(yes)/N(no) in FIG. 4, the method proceeds the repeating until all remaining unprocessed voxels are processed. This means in practice that the first set of neighbor voxels become a second set of neighbor voxels to the new first element in the queue. As an example the method continues by

identifying 422 a second set of neighbor voxels to the first element of the queue, having Hounsfield values under the predetermined threshold,

inserting 423 the second set of neighbor voxels into the queue,

registering 424 the maximum Hounsfield value encountered for the second voxel on a heritage path from the seed voxel,

marking 425 the second voxel and the second set of neighbor voxels, e.g. with a high Hounsfield value above the predetermined threshold, such that it will never enter the queue again,

deleting 426 the second voxel from the queue,

calculating 427 the structure as the difference or ratio between the maximum

Hounsfield value and the actual second voxel Hounsfield value. The method then proceeds in the same manner until all of the voxels of the medical image dataset are processed.

A great advantage of this embodiment is that the structure is quantified along a heritage path, which in some way reflects the air travel path from the trachea to the lungs. Using prior art methods this is not possible. Another advantage of the method is to find trapped air in the lungs. The tissue surrounding the trapped air has higher Hounsfield value than the trapped air itself. Utilizing this embodiment the trapped air is separated from the surrounding tissue as the air has a lower Hounsfield value than that of the surrounding tissue. A difference of using the method according to some embodiments compared to prior art methods is that the maximum Hounsfield value used to quantify the trapped air in the present invention is not fix for the total medical image dataset but is defined as the maximum Hounsfield value of the heritage path.

As all voxels put into the queue are marked in the marking 416, 425 steps the same voxel will never be comprised in the queue at several positions. Thus the size of the queue will never be greater than the total number of voxels in the investigated image dataset.

In an embodiment, the trapped air may be located in the lung wall or any other location in the human body, such as in the bowels of the patient.

In an embodiment the trapped air may be any other structure of interest in an image dataset.

In an embodiment the seed voxel is located in the trachea of the patient. The seed voxel may e.g. be spherical air-filled holes of suitable diameter, such as 10-30 mm.

In an embodiment the predetermined Hounsfield value is −400 HU and is used to determine trapped air in the medical image dataset.

In an embodiment the neighbor voxels is the direct neighbor voxels to a voxels in a 3D medical image data, i.e. 3³−1=26 direct neighbor voxels.

In an embodiment the neighbor voxels is the direct neighbor voxels to a voxels in a 2D medical image data, i.e. 3²−1=8 direct neighbor voxels.

The calculating step of the method according to an embodiment yields high trappedness values for voxels with low Hounsfield values, approaching pure air, that are shielded by strong tissue encapsulation indicated by high Hounsfield walls.

In an embodiment the method further comprises visualizing 418 the quantified trappedness, i.e. total amount of trapped air volume, for the whole lung, and e.g. separately for the left and right lung and the separate lung lobes. The visualization comprises efficiently displaying the location and extent of the trapped air regions to a user for inspection and diagnosis.

In an embodiment the visualizing of the trappedness comprises a color overlay over the medical image dataset, such as for each slice of the image dataset, wherein the color intensity corresponds to the amount of trappedness in the medical image dataset.

In an embodiment the seed voxel is found by thresholding a 2D medical image dataset comprising the trachea a predetermined Hounsfield value, such as −400 HU, to separate air from tissue, grouping all voxels below the threshold based on some criterion, such as Hounsfield intervals of 50 HU, checking for similarity for each group whether its extension is similar to the trachea, computing the “roundness” of each group by calculating the perimeter to area ratio which gives low values for a round group, and computing the centroid for the group voxel area which has the lowest perimeter to area ratio, e.g. for each dimension (such as x, y, z) summing Hounsfield values for voxels along the dimension axis divided by the number of voxels along the dimension axis, and is most central in the 2D medical image dataset, and, and setting the centroid as a seed voxel in the trachea.

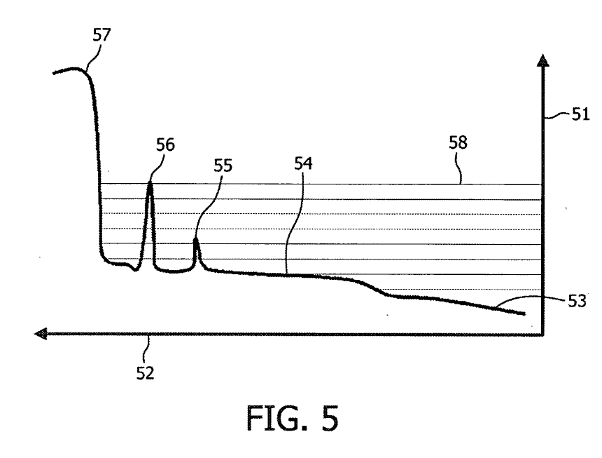

FIG. 5 illustrates a Hounsfield profile for a lung region of a patient comprising trapped air along a heritage path. FIG. 5 also illustrates the principle of the method with prioritized segmentation by region growing according to an embodiment (low Hounsfield values first) from the trachea 53 to the lung wall 57 via the smaller airways 54. In FIG. 5 the y-axis 51 illustrates the Hounsfield value and x-axis 52 illustrates a heritage path. When the method, according to an embodiment, is used reference 58 indicates the maximum Hounsfield level that was encountered during the low-Hounsfield value priority region growing. As can be observed in FIG. 5 two peaks are present in the Hounsfield profile, slightly trapped air 35 and strongly trapped air 36, respectively. These are identified as trapped air as the voxels comprising air (low Hounsfield value) are separated from the surrounding tissue (high Hounsfield value).

Due to the low Hounsfield prioritization, i.e. low Hounsfield values processed first, the algorithm reaches each voxel on a path with the lowest possible Hounsfield values.

In an embodiment the method may be performed automatically without any user interaction.

In an embodiment the medical image dataset is a volumetric CT image dataset.

In an embodiment the medical image dataset is a 2D, 3D or multi-dimensional image dataset.

Alternatively of performing region growing the method according to an embodiment comprises performing known level-set methods or fast-marching methods. These are more complex methods for describing neighbor voxels, e.g. utilizing weighting the neighbor voxels having individual velocities in different directions that are faster for voxels with lower Hounsfield values. Such methods are for instance described in J. A. Sethian, Level Set Methods and Fast Marching Methods, Cambridge University Press, 1999.

In an embodiment a graphical user interface for visualizing the method according to some embodiments is provided. The graphical user interface visualizes the amount of trappedness by a color overlay over the medical image dataset, such as each slice of the image dataset, wherein the color intensity corresponds to the amount of trappedness in the medical image dataset.

In an embodiment the graphical user interface comprises a second visualization that is computed as a maximum intensity projection (MIP) of the trappedness values, wherein the trappedness corresponds to brightness. A MIP is a two-dimensional projection of a three-dimensional image volume along a given viewing direction. For each point in the two-dimensional projection, a ray is cast along the given viewing direction through the 3D volume, and then the point in the 2D projection is assigned the maximum value that was encountered along the ray. In this way, lower brightness values in the 3D volume can never occlude higher brightness values. The viewing direction may be freely chosen by the user, e.g. by mouse interaction, or automatically rotated around a given axis, such as the vertical body axis.

In an embodiment the MIP is computed in a coronal/sagittal direction, for all possible angular directions (360 degrees), rotating around the z-axis of the data set. In this way, the severity of the air trappings and their extent may be appraised in one glance, and strong air trappings cannot be overlooked due to their bright appearance in the MIP, which by its nature does not allow occlusions by objects of lesser brightness (here trappedness). This means that the trapped air areas will always “shine through” normal areas in the foreground.

In an embodiment the coordinate system of the MIP is related to the coordinate system of the image dataset, meaning that when e.g. moving a cursor over the image dataset the corresponding cursor location is indicated in the MIP, and conversely.

In an embodiment of the invention the graphical user interface is integrated into an image viewer, such as an orthoviewer.

A mouse may be used to click into the MIP, resulting in that the graphical user interface, integrated in an image viewer, is automatically set to the corresponding position in the image dataset indicated e.g. by a cross hair.

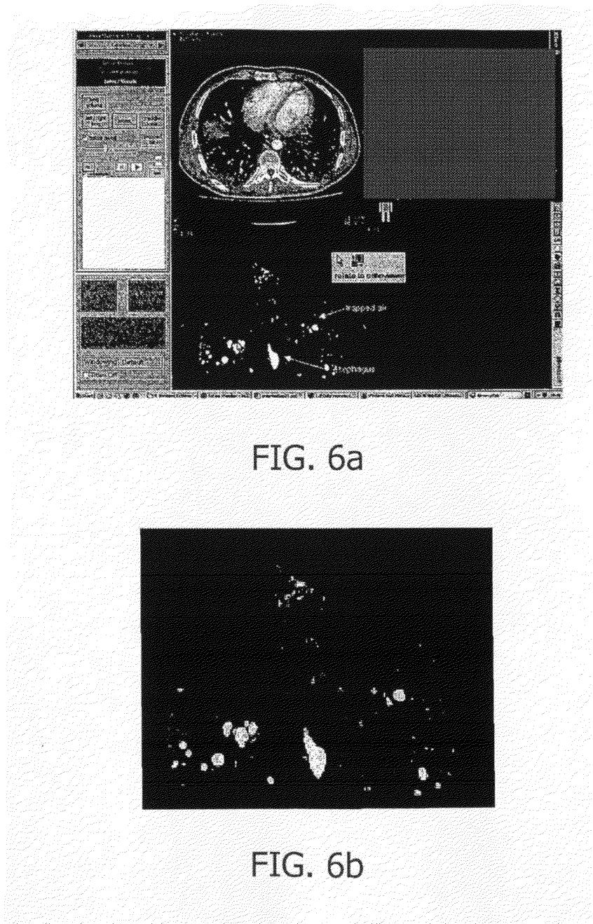

In an embodiment, according to FIG. 6a, a graphical user interface is provided. The user interface comprises an orthoviewer of the CT dataset, showing the amount of trappedness by the intensity of the red overlay color. Moreover the graphical user interface comprises a rotating, coronal, maximum intensity projection (MIP) of the trappedness-values in the lung, showing in one glance where the trapped air regions are located, their extent and severity (coded as brightness). A mouse-click into the MIP sets the orthoviewer (top center) to the corresponding position in the axial/coronal/sagittal slice images (marked by cross hair). FIG. 4b illustrates is a zoomed view of the MIP.

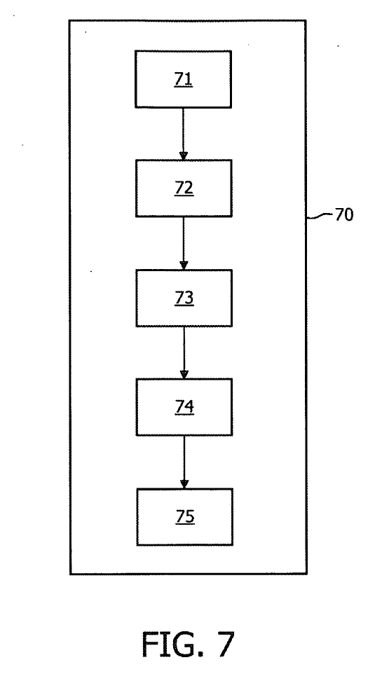

In an embodiment, according to FIG. 7, an apparatus 70 for quantification of trapped air in a medical image dataset is provided. The apparatus comprises units for performing the method according to embodiments of the invention. The apparatus comprises:

a performing unit 71 for performing segmentation of the medical image dataset to identity the trapped air, wherein the segmentation is based on processing each voxel in the medical image dataset in the order of its respective Hounsfield value,

a registering unit 72 for registering the maximum Hounsfield value encountered so far on a heritage path from the seed voxel, wherein the heritage path for all voxels in the image dataset begins with the seed voxel, and

a calculating unit 73 for calculating the trapped air for each voxel by comparing the maximum heritage path Hounsfield value and the actual voxel Hounsfield value, e.g. as a difference or ratio. The trapped air is in this manner separated and quantified from other voxels of the medical image dataset such as voxels describing the bronchial airway tree.

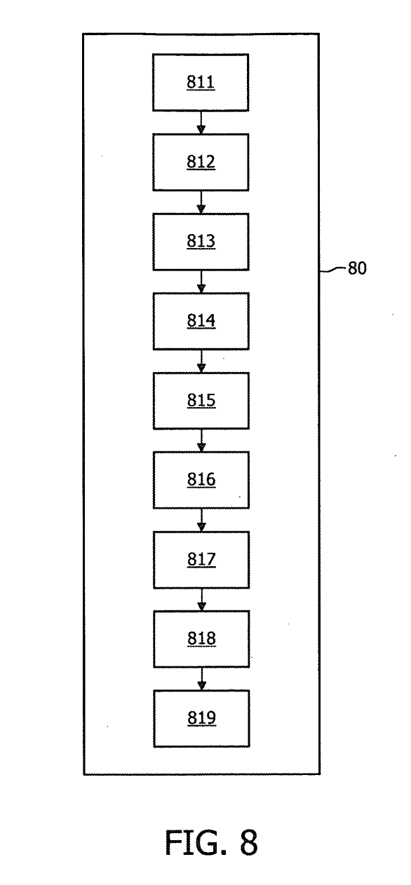

In another embodiment, according to FIG. 8, an apparatus 80 is provided for quantification of a structure in a medical image dataset having a plurality of voxels, each voxel having a Hounsfield value (HU), wherein the structure comprises a seed voxel and a first voxel that initially are identical. The apparatus comprises:

an inserting unit 811 for inserting the first voxel as a first element into a queue, in which voxels are organized by increasing Hounsfield value, and

a repeating unit comprising:

an identifying unit 812 for identifying a first set of neighbor voxels to the first element of the queue, having Hounsfield values under a predetermined threshold,

an inserting unit 813 for inserting the first set of neighbor voxels into the queue,

a registering unit 814 registering for the first voxel the Hounsfield value encountered on a path originating from the seed voxel, wherein the path is a sequence of voxels comprised in the plurality of voxels and wherein each successive voxel of the path is a neighbor voxel of a previously processed voxel, and that each voxel of the path is chosen from the queue,

a calculating unit 815 for calculating the difference or ratio between the maximum Hounsfield value of all voxels on the path and the Hounsfield value of the first voxel to quantify the structure voxel by voxel,

a marking unit 816 for marking the first voxel, such that it subsequently not will enter the queue again,

for repeating until all remaining unprocessed voxels are processed and the queue is empty.

Optionally the apparatus may comprise a deleting unit 817 for deleting the first voxel from the queue.

In an embodiment of the invention the apparatus 70, 80 further comprises a render unit 74, 818 for rendering a 2D or 3D visualization of the quantified trappedness. If no deleting unit 817 is present the render unit 74, 818 is directly connected to the repeating unit or the marking unit (816) within the repeating unit.

In an embodiment the apparatus comprises suitable units for performing the method according to some embodiments of the invention.

The unit of the apparatus may be any units normally used for performing the involved tasks, e.g. a hardware, such as a processor with a memory. The processor may be any of variety of processors, such as Intel or AMD processors, CPUs, microprocessors,

Programmable Intelligent Computer (PIC) microcontrollers, Digital Signal Processors (DSP), etc. However, the scope of the invention is not limited to these specific processors. The memory may be any memory capable of storing information, such as Random Access Memories (RAM) such as, Double Density RAM (DDR, DDR2), Single Density RAM (SDRAM), Static RAM (SRAM), Dynamic RAM (DRAM), Video RAM (VRAM), etc. The memory may also be a FLASH memory such as a USB, Compact Flash, SmartMedia, MMC memory, MemoryStick, SD Card, MiniSD, MicroSD, xD Card, TransFlash, and MicroDrive memory etc. However, the scope of the invention is not limited to these specific memories.

In an embodiment the apparatus 70, 80 further comprises a display unit 75, 819 for displaying the rendered 2D or 3D visualization to a user.

In an embodiment the apparatus 70, 80 is comprised in a medical workstation or medical system, such as a Computed Tomography (CT) system or Magnetic Resonance Imaging (MRI) system.

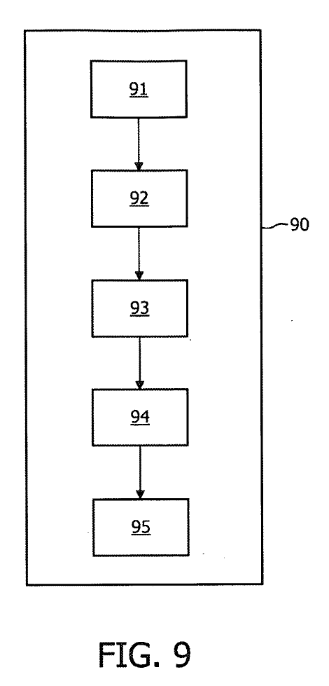

In an embodiment, according to FIG. 9, a computer-readable medium 90 having embodied thereon a computer program for processing by a computer is provided for quantification of a structure in an object of an image dataset. The computer program comprises code segments for performing the method according to embodiments of the invention. The computer program comprises:

a performing code segment 91 for performing segmentation of the medical image dataset to identity the trapped air, wherein the segmentation is based on processing each voxel in the medical image dataset in the order of its respective Hounsfield value,

a registering code segment 92 for registering the maximum Hounsfield value encountered so far on a heritage path from the seed voxel, wherein the heritage path for all voxels in the image dataset begins with the seed voxel, and

a calculating code segment for calculating 93 the trapped air for each voxel by comparing the maximum heritage path Hounsfield value and the actual voxel Hounsfield value, e.g. as a difference or ratio. The trapped air is in this manner separated and quantified from other voxels of the medical image dataset such as voxels describing the bronchial airway tree.

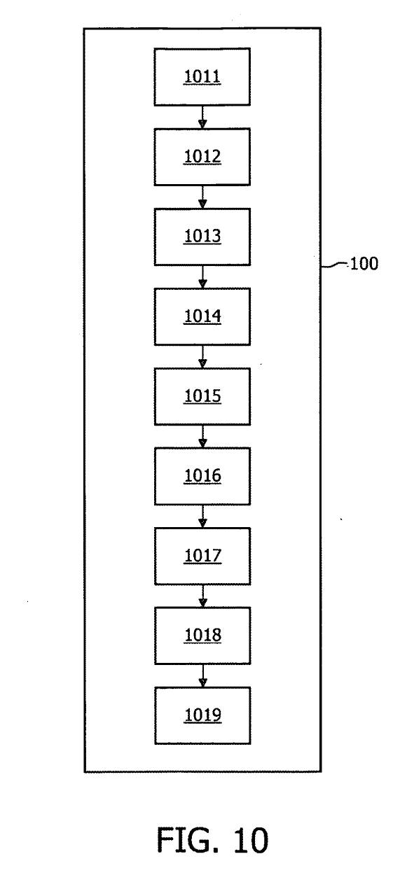

In an embodiment, according to FIG. 10, a computer readable medium 100 is provided, having embodied thereon a computer program for processing by a computer for quantification of a structure in a medical image dataset having a plurality of voxels, each voxel having a Hounsfield value (HU), wherein the structure comprises a seed voxel and a first voxel that initially are identical. The computer program comprises:

an inserting code segment 1011 for inserting the first voxel as a first element into a queue, in which voxels are organized by increasing Hounsfield value, and

a repeating code segment comprising:

an identifying code segment 1012 for identifying a first set of neighbor voxels to the first element of the queue, having Hounsfield values under a predetermined threshold,

an inserting code segment 1013 for inserting the first set of neighbor voxels into the queue,

a registering code segment 1014 registering for the first voxel the Hounsfield value encountered on a path originating from the seed voxel, wherein the path is a sequence of voxels comprised in the plurality of voxels and wherein each successive voxel of the path is a neighbor voxel of a previously processed voxel, and that each voxel of the path is chosen from the queue,

a calculating code segment 1015 for calculating the difference or ratio between the maximum Hounsfield value of all voxels on the path and the Hounsfield value of the first voxel to quantify the structure voxel by voxel,

a marking code segment 1016 for marking the first voxel, such that it subsequently not will enter the queue again,

for repeating until all remaining unprocessed voxels are processed and the queue is empty.

Optionally the computer program comprises a deleting code segment 1017 for deleting the first voxel from the queue.

In an embodiment the computer-readable medium comprises a code segment for performing the method according all of the embodiments of the invention.

In an embodiment the computer program further comprises a render code segment 1018 for rendering a 2D or 3D visualization of the computed trappedness.

In an embodiment the computer program further comprises a display code segment 1019 for displaying the rendered 2D or 3D visualization of the quantified trappedness.

In an embodiment the computer-readable medium comprises code segments arranged, when run by an apparatus having computer-processing properties, for performing all of the method steps defined in some embodiments.

In an embodiment the method, apparatus and computer readable medium is used for locating and diagnosing trapped air in a patient.

Applications and use of the above-described embodiments according to the invention are various and include many other areas wherein quantification of structures in a volume of interest is desired.

The invention may be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

Although the present invention has been described above with reference to specific embodiments, it is not intended to be limited to the specific form set forth herein. Rather, the invention is limited only by the accompanying claims and, other embodiments than the specific above are equally possible within the scope of these appended claims.

In the claims, the term “comprises/comprising” does not exclude the presence of other elements or steps. Furthermore, although individually listed, a plurality of units, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1. A method for quantification of a structure in a medical image dataset having a plurality of voxels, each voxel having a Hounsfield value (HU), wherein said structure comprises a seed voxel and a first voxel that initially are identical, said method comprising the steps of:
inserting said first voxel as a first element into a queue, in which voxels are organized by increasing Hounsfield value, and repeating:
identifying a first set of neighbor voxels having Hounsfield values under a predetermined threshold,
inserting said first set of neighbor voxels into said queue,
registering for said first voxel the Hounsfield value encountered on a path originating from said seed voxel, wherein said path is a sequence of voxels in said plurality of voxels and wherein each successive voxel of the path is a neighbor voxel of a previously processed voxel, and that each voxel of the path is chosen from the queue,
calculating a difference or ratio between a maximum Hounsfield value of all voxels on said path and the Hounsfield value of said first voxel to quantify said structure voxel by voxel,
marking said first voxel and the first set of neighbor voxels, such that they will not subsequently enter said queue again, until all remaining unprocessed voxels are processed and the queue is empty.

2. The method according to claim 1, wherein said structure is trapped air in the human body.

3. The method according to claim 1, wherein said predetermined threshold value is −400 HU.

4. The method according to claim 1, wherein said medical image dataset is a Computed Tomography volumetric image dataset.

5. The method according to claim 1, wherein said medical image dataset is a 2D, 3D or 4D image dataset.

6. The method according to claim 1, wherein said seed voxel is located by:
thresholding a 2D trachea medical image dataset by said predetermined threshold value to separate air from tissue,
grouping all voxels below the threshold,
checking for similarity for each group whether its extension is similar to the trachea,
computing the roundness of each group by calculating a perimeter to area ratio presenting low values for a round group,
computing a centroid for a group voxel area which has a lowest perimeter to area ratio, and
setting the centroid as a seed voxel in the trachea.

7. The method according to claim 1, wherein said seed voxel is spherical air-filled holes located in a lung region of a patient.

8. The method according to claim 1, wherein said calculating yields high structure quantification values for voxels with low Hounsfield values, approaching pure air, that are shielded by surrounding tissue of higher Hounsfield values.

9. The method according to claim 1, wherein said method is performed automatically without any user interaction.

10. The method according to claim 1, further comprising, visualizing said quantification of said structure by displaying a location and extent of said structure to a user for inspection and diagnosis.

11. The method according to claim 10, wherein said visualizing comprises a color overlay over said medical image dataset, wherein the color intensity corresponds to said quantification of said structure.

12. A graphical user interface for visualizing quantification of a structure in a medical image dataset by a color overlay over said medical image dataset, wherein the color intensity corresponds to quantification of a structure calculated by the method according to claim 1.

13. The graphical user interface according to claim 12, further comprising a second visualization computed as a maximum intensity projection of said quantification of said structure, wherein said quantification corresponds to brightness.

14. The graphical user interface according to claim 13, wherein said maximum intensity projection is computed in a coronal/sagittal direction, for all angular directions, rotating around the z-axis of said medical image dataset.

15. The graphical user interface according to claim 12, wherein an image viewer, such as an orthoviewer, displays slices of said medical image dataset, showing said quantification of said structure by the intensity of a red overlay color.

16. The graphical user interface according to claim 15, further comprising a rotating, coronal, maximum intensity projection of said quantification of said structure, showing the location of said structure, the extent and severity coded as brightness.

17. The graphical user interface according to claim 13, wherein the coordinate system of the Maximum Intensity Projection is related to the coordinate system of said medical image dataset.

18. The graphical user interface according to claim 15, wherein a mouse-click into the Maximum Intensity Projection sets the image viewer to the corresponding position in said image dataset.

19. An apparatus (80) for quantification of a structure in a medical image dataset having a plurality of voxels, each voxel having a Hounsfield value (HU), wherein said structure comprises a seed voxel and a first voxel that initially are identical, said apparatus comprising:
an inserting unit (811) for inserting said first voxel as a first element into a queue, in which voxels are organized by increasing Hounsfield value, and
a repeating unit comprising:
an identifying unit (812) for identifying a first set of neighbor voxels having Hounsfield values under a predetermined threshold,
an inserting unit (813) for inserting said first set of neighbor voxels into said queue,
a registering unit (814) registering for said first voxel the Hounsfield value encountered on a path originating from said seed voxel, wherein said path is a sequence of voxels in said plurality of voxels and wherein each successive voxel of the path is a neighbor voxel of a previously processed voxel, and that each voxel of the path is chosen from the queue,
a calculating unit (815) for calculating a difference or ratio between a maximum Hounsfield value of all voxels on said path and the Hounsfield value of said first voxel to quantify said structure voxel by voxel,
a marking unit (816) for marking said first voxel, such that it will subsequently enter said queue again, for repeating until all remaining unprocessed voxels are processed and the queue is empty.

20. The apparatus (80) according to claim 19, further comprising a render unit (818) for rendering a 2D or 3D visualization of the computed difference between the highest encountered Hounsfield path value and the actual value of each voxel.

21. The apparatus according to claim 19, further comprising a display unit (819) for displaying the rendered 2D or 3D visualization to a user.

22. The apparatus (80) according to claim 19, being comprised in a medical workstation or medical system, such as a Computed Tomography (CT) system, Magnetic Resonance Imaging (MRI) System or Ultrasound Imaging (US) system.

23. A computer readable medium (100) having embodied thereon a computer program for processing by a computer for quantification of a structure in a medical image dataset having a plurality of voxels, each voxel having a Hounsfield value (HU), wherein said structure comprises a seed voxel and a first voxel that initially are identical, said computer program comprising:
an inserting code segment (1011) for inserting said first voxel as a first element into a queue, in which voxels are organized by increasing Hounsfield value, and
a repeating code segment comprising:
an identifying code segment (1012) for identifying a first set of neighbor voxels having Hounsfield values under a predetermined threshold,
an inserting code segment (1013) for inserting said first set of neighbor voxels into said queue,
a registering code segment (1014) registering for said first voxel the Hounsfield value encountered on a path originating from said seed voxel, wherein said path is a sequence of voxels in said plurality of voxels and wherein each successive voxel of the path is a neighbor voxel of a previously processed voxel, and that each voxel of the path is chosen from the queue,
a calculating code segment (1015) for calculating a difference or ratio between a maximum Hounsfield value of all voxels on said path and the Hounsfield value of said first voxel to quantify said structure voxel by voxel,
a marking code segment (1016) for marking said first voxel, such that it will not subsequently enter said queue again, for repeating until all remaining unprocessed voxels are processed and the queue is empty.

24. (canceled)

25. The method according to claim 1, herein said method is processed for diagnosing trapped air in a patient.
